(19) United States
(12) Patent Application Publication
(10) Pub. No.: US 2010/0312928 A1
(43) Pub. Date: Dec. 9, 2010

(54) SYSTEM AND METHOD FOR OPERATING A COMMUNICATION LINK

(76) Inventors: Paul V. Brownell, Houston, TX (US); Barry S. Basile, Houston, TX (US); David L. Matthews, Cypress, TX (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/481,139

(22) Filed: Jun. 9, 2009

(51) Int. Cl. G06F 3/00

(52) U.S. Cl. 710/57; 710/105

(57) ABSTRACT

There is provided a system and method of controlling transaction flow in a communications interface. An exemplary system comprises a first buffer configured to hold packets of a first packet type, and a second buffer configured to hold packets of a second packet type. An exemplary system also comprises a counter configured to track a delay-reference of packets held in the second buffer. An exemplary system also comprises a controller configured to receive packets from a host and send packets of the first packet type to the first buffer and to send packets of the second packet type to the second buffer, the controller being further configured to stop receiving packets if the delay-reference meets or exceeds a specified threshold.

### BACKGROUND

The Peripheral Component Interconnect Express (PCIe) standard is widely used in digital communications for a variety of computing systems. In a PCIe network, various electronic devices are coupled through one or more serial links controlled by a central switch. The switch controls the coupling of the serial links and, thus, the routing of data between components. Each serial link or “lane” carries streams of information packets between the devices. Furthermore, each lane may be further divided by dividing the packets into three packet types: posted packets, non-posted packets, and completion packets. Each packet type may be processed as a separate packet stream. Furthermore, to enable quality of service (QoS) between the three packet types, each type of packet may be assigned a different priority level. A packet stream designated as the higher priority type will generally be processed more often than packet streams designated as the lower-priority type. In this way, the higher priority packet stream will generally have access to the lane more often than lower-priority packet streams and will therefore consume a larger portion of the lane's bandwidth.

Prioritizing packet types can, however, lead to a situation known as “starvation,” which occurs when higher priority packet types consume nearly all of the lane's bandwidth and lower-priority packets are not processed with sufficient speed. Packet starvation may result in poor performance of devices coupled to the PCIe network.

### BRIEF DESCRIPTION OF THE DRAWINGS

Certain exemplary embodiments are described in the following detailed description and in reference to the drawings, in which:

FIG. 1 is a block diagram of a PCIe fabric with a PCIe interface adapted to prevent starvation of lower-priority packets, according to an exemplary embodiment of the present invention;

FIG. 2 is a block diagram that shows the PCIe interface of FIG. 1, according to an exemplary embodiment of the present invention;

FIG. 3 is a flow chart of a method by which the PCIe interface may receive packets from a host, according to an exemplary embodiment of the present invention;

FIG. 4 is a flow chart of a method by which the PCIe interface may send packets to a network, according to an exemplary embodiment of the present invention; and

FIG. 5 is a block diagram of a computer system that may embody one or more of the functional blocks of the PCIe interface shown in FIG. 2, according to an exemplary embodiment of the present invention.

### DETAILED DESCRIPTION OF SPECIFIC EMBODIMENTS

In accordance with an exemplary embodiment of the present invention, a PCIe interface receives a stream of packets from a first device, processes the packets and sends the packets to a second device, giving the highest priority to posted packets. Starvation of the lower-priority packet streams is avoided by using a counter that tracks the arrival and subsequent transmission of lower-priority packets to ensure that the lower-priority packets are processed within a sufficient amount of time. If a lower-priority packet is not processed before the counter reaches a specified threshold, the PCIe interface generates a “stop-credit” signal that temporarily stops the PCIe interface from receiving packets. By stopping the PCIe interface from receiving additional packets, all of the posted packets will eventually be processed and sent to the second device, thereby enabling the PCIe interface to begin processing lower-priority packets. Sometime after beginning to process lower-priority packets, the stop-credit signal may be deactivated, and the PCIe interface may again begin receiving additional packets. Using this process, some or all of the lower-priority packets may be processed and sent to the second device before the PCIe interface receives additional posted packets. Thus, starvation of the lower-priority packet stream is avoided while ensuring that the posted packets are processed ahead of the lower-priority packets.

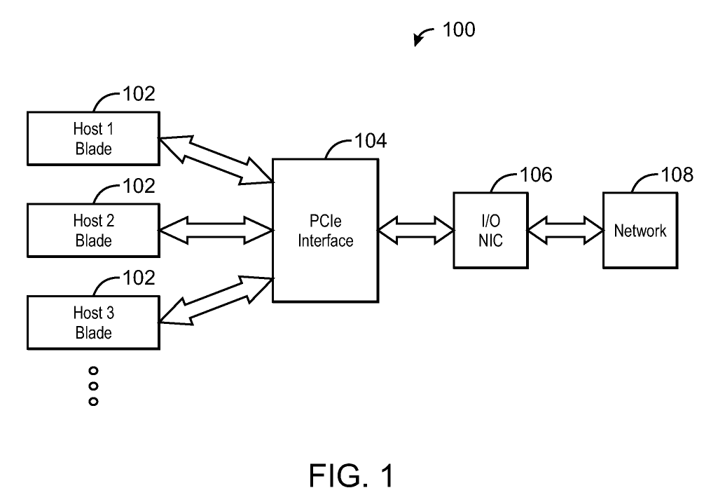

FIG. 1 is a block diagram of a PCIe fabric with a PCIe interface adapted to prevent starvation of lower-priority packets according to an exemplary embodiment of the present invention. The PCIe fabric is generally referred to by the reference number 100. It will be appreciated that although exemplary embodiments of the present invention are described in the context of a PCIe fabric, embodiments of the present invention may include any computer system that employs the PCIe or similar communication standard.

Those of ordinary skill in the art will appreciate that the PCIe fabric 100 may comprise hardware elements including circuitry, software elements including computer code stored on a machine-readable medium or a combination of both hardware and software elements. Additionally, the functional blocks shown in FIG. 1 are but one example of functional blocks that may be implemented in an exemplary embodiment of the present invention. Those of ordinary skill in the art would readily be able to define specific functional blocks based on design considerations for a particular computer system.

A computing fabric generally includes several networked computing resources, or “network nodes,” connected to each other via one or more network switches. In an exemplary embodiment of the present invention, the nodes of the PCIe fabric 100 may include several host blades 102. The host blades 102 may be configured to provide any suitable computing function, such as data storage or parallel processing, for example. The PCIe fabric 100 may include any suitable number of host blades 102. The host blades 102 may be communicatively coupled to each other through a PCIe interface 104, an I/O device such as a network interface controller (NIC) 106, and a network 108. The host blade 102 is communicatively coupled to the network 108 through the PCIe interface 104 and the NIC 106, enabling the host blades 102 to communicate with each other as well as other devices coupled to the network 108. The PCIe interface 104 couples the host blades 102 to the NIC 106 and may also couple one or more host blades 102 directly. The PCIe interface 104 may include a switch that allows the PCIe interface 104 to couple to each of the host blade 102 alternatively, enabling each of the host blades 102 to share the PCIe interface 104 to the NIC 106.

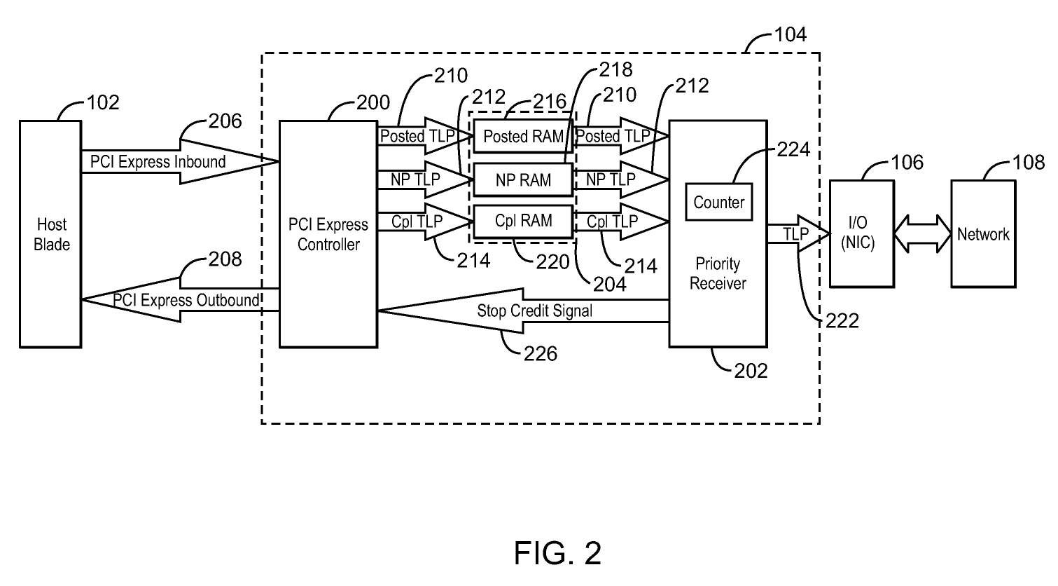

The PCIe interface 104 receives streams of packets from the host blade 102, processes the packets, and organizes the packets into another packet stream that is then sent to the NIC 106. The NIC 106 then sends the packets to the target device through the network 108. The target device may be another host blade 102 or some other device coupled to the network 108. The network 108 may be any suitable network, such as a local area network or the Internet, for example. As discussed above, the PCIe interface 104 may be configured to receive three types of packets from the host blade 102, and each packet type may be accorded a designated priority. Accordingly, the PCIe interface may be configured to receive and process higher priority packets ahead of lower-priority packets, while also preventing starvation of the lower-priority packet stream. The PCIe interface 104 is described further below with reference to FIG. 2.

FIG. 2 is a block diagram that shows additional details of the PCIe interface 104 of FIG. 1 according to an exemplary embodiment of the present invention. As shown in FIG. 2, the PCIe interface 104 may include a PCIe controller 200, a priority receiver 202, and a memory 204. The PCIe controller 200 receives inbound traffic 206 from the host blade 102 and sends outbound traffic 208 to the host blade 102. The inbound traffic 206 received by the PCIe controller 200 from the host blade 102 may include a stream of transition layer packets (TLPs), referred to herein simply as “packets.” Packets may be classified according to three packet types: posted packets 210, non-posted packets 212, and completion packets 214. Each packet 210, 212, or 214 includes header information that identifies the packet's type, followed by instructions or data. Generally, posted packets 210 are used for memory writes and message requests, non-posted packets 212 are used for memory reads requests and I/O or configuration write requests, and completion packets 214 are used to return the data requested by a read request as well as I/O and configuration completions. Posted packets 210 generally include header information that corresponds with a target memory location of a target device and the data that is to be written to the target memory location. Non-posted packets 212 generally include header information that corresponds with a target memory location of a target device from which data will be read. Completion packets 214 generally include header information indicating that the completion packet is being sent in response to a specific read request and the data requested. The packets 210, 212, and 214 may be any suitable size, for example, 64 bytes, 128 bytes, 256 bytes, 512 bytes, 1024 bytes or the like.

PCIe transactions generally employ a credit-based flow control mechanism to ensure that the receiving device has enough capacity, for example, buffer space, to receive the data being sent. Accordingly, the PCIe controller 200 transmits flow control credits to the host blade 102 via the PCIe outbound traffic 208. The flow control credits grant the host blade 102 the privilege to send a certain number of packets to the PCIe controller 200. As packets are transmitted to the PCIe controller 200, the flow control credits are expended. Once all of the credits are used, the host blade 102 may not send additional packets to the PCIe controller 200 until the PCIe controller 200 grants additional credits to the host blade 102. As the PCIe controller 200 processes the received packets, additional buffer capacity may become available within the PCIe controller 200 and additional credits may be granted to the host blade 102. As long as the PCIe controller 200 grants sufficient credits to the host blade 102, a steady stream of packets may be sent from the host blade 102 to the PCIe controller 200. If, however, the PCIe controller 200 stops granting credits to the host blade 102, the host blade 102 will, likewise, stop sending packets to the PCIe controller 200 as soon as the flow control credits granted to the host blade 102 have been expended.

When the PCIe controller 200 receives an inbound packet, it interprets the packet type information in the packet header and sends the packet to the memory 204. The memory 204 may be used to temporarily hold packets that are destined for the priority receiver 202, and may include any suitable memory device, such as a random access memory (RAM), for example. Furthermore, the memory 204 may be divided into separate buffers for each packet type, referred to herein as the posted RAM 216, the non-posted RAM 218, and the completion RAM 220, each of which may be first-in-first-out (FIFO) buffers. Furthermore, the RAM buffers 216, 218, and 220 may hold any suitable number of packets. In some embodiments, for example, each of the RAM buffers 216, 218, and 220 may hold approximately 128 packets. Packets received by the PCIe controller 200 from the host blade 102 may be sent to the one or more RAM buffers 216, 218, and 220 according to packet type. Posted packets 210 are sent to the posted RAM 216, non-posted packets 212 are sent to the non-posted RAM 218, and completion packets 214 are sent to the completion RAM 220. If any one of the RAM buffers 216, 218, and 220 become full, the PCIe controller 200 will temporarily stop issuing flow control credits to the host blade 102.

As packets 210, 212, and 214 are stored to the respective RAM buffers 216, 218, and 220 by the PCIe controller 200, packets 210, 212, or 214 are simultaneously retrieved by the priority receiver 202, one packet at a time. The priority receiver 202 switches alternatively between the posted RAM 216, the non-posted RAM 218, and the completion RAM 220, retrieving packets and ordering the packets into a single packet stream 222 that is transmitted to the NIC 106. Each time the priority receiver 202 receives a packet 210, 212, or 214, the packet is placed next in line in the packet stream 222 and sent to the NIC 106. Therefore, the resulting packet stream 222 is determined by the order in which packets are received from the RAM buffers 216, 218, and 220. Moreover, the frequency with which the priority receiver 202 receives packets from any one of the posted RAM 216, the non-posted RAM 218, or the completion RAM 220 determines the relative bandwidth accorded to each of the packet streams represented by the three different packet types.

The order in which the packets 210, 212, or 214 are received from the memory 204 is determined, in part, by the priority assigned to each packet type. It will be appreciated that if the PCIe interface 104 does not process packets in a suitable order, it may be possible, in some cases, for the host blade 102 to obtain outdated information in response to a memory read operation. In other words, if the PCIe interface 104 sends a later-arriving read operation (non-posted packet) to the NIC 106 before an earlier-arriving write operation (posted packet) directed to the same memory location of the target device, the data returned in response to the read operation may not be current. To avoid this situation, embodiments of the present invention assign the highest priority to posted packets 210 (memory writes). This means that the priority receiver 202 will receive posted packets 210 from the posted RAM 216 whenever there are posted packets 210 available in the posted RAM 216. In other words, non-posted packets 212 and completion packets 214 will not be received by the priority receiver 202 unless the posted RAM 216 is empty. Assigning the highest priority to posted packets 210 in this way avoids the possible problem of processing a later-arriving read operation ahead of an earlier-arriving write operation.

However, one consequence of giving posted packets 210 the highest priority is that if the host blade 102 provides a steady stream of posted packets 210 to the PCIe controller 200, the non-posted packets 212 and completion packets 214 may not be retrieved and processed by the priority receiver 202 for a significant amount of time. Failure to process lower-priority packets in a timely manner may hinder the performance of one of the devices coupled to the PCIe fabric 100. In some instances, for example, failure to timely process a completion packet 214 may result in a completion time-out, in which case the requesting device may send a duplicate read request. The PCIe standard provides that a device may initiate a completion time-out within 50 microseconds to 50 milliseconds after sending a read request.

Therefore, exemplary embodiments of the present invention also include techniques for enabling lower-priority packets to be processed in a timely manner. Accordingly, the priority receiver 202 may include a counter 224 that provides a value referred to herein as a “delay-reference.” In some embodiments, the delay-reference may be an amount of time that a lower-priority packet has been held in the non-posted RAM 218 and/or the completion RAM 220. In other embodiments, the delay-reference may be a count of the number of posted packets 210 that have been received by the priority receiver 202 from the posted RAM 216 while a lower-priority packet has been held in the non-posted RAM 218 and/or the completion RAM 220. If the delay-reference for a lower-priority packet exceeds a certain threshold, referred to herein as the “stop-credit threshold,” the priority receiver 202 issues a stop-credit signal 226 to the PCIe controller 200. The PCIe controller 200 in turn stops sending flow control credits to the host blade 102. As discussed above, this causes the host blade 102 to stop sending packets to the PCIe controller 200. As a result, the PCIe controller 200 will eventually run out of packets to send to the memory 204. Meanwhile, the priority receiver 202 continues to receive and process packets from the memory 204. When all of the posted packets 210 have been received from the posted RAM 216, the priority receiver 202 then starts receiving and processing the lower-priority packets from the non-posted RAM 218 and the completion RAM 220. The stop-credit signal 226 may be maintained long enough for one or more of the lower-priority packets to be processed before additional posted packets 210 become available in the posted RAM 216.

The delay-reference tracking of the lower-priority packets may be accomplished in a variety of ways. For example, the counter 224 may count an actual time such as the number of microseconds or milliseconds that have passed since the counter 224 was started or reset, for example. Accordingly, the counter 224 may be coupled to a clock and configured to count clock pulses. In this case, the stop-credit threshold may be some fraction of the maximum or minimum completion packet timeout defined by the PCIe standard. For example, in an exemplary embodiment, the stop-credit threshold may be 50 percent of the minimum completion packet timeout, or 25 microseconds. Setting the stop-credit threshold at a fraction of the completion timeout may allow lower-priority packets to be processed in sufficient time to prevent a requesting device from timing out and resending another request packet.

Alternatively, the counter may count a number of packets that have been processed by the priority receiver 202 since the arrival of a low priority packet, and the stop-credit threshold may be specified as any suitable number of high priority packets, for example, 4, 8 or 256 posted packets. In other words, upon the arrival of a lower-priority packet, the counter 224 may begin counting the number of posted packets 210 received by the priority receiver 202. If the counter 224 reaches the specified packet count threshold before a lower-priority packet is processed, then the stop-credit signal is issued. This technique allows an approximate upper limit to be placed on the number of posted packets 210 that may be processed before processing of non-posted packets 212 or completion packets 214 is performed. For example, the stop-credit threshold may be set at 8, in which case the stop-credit signal may be sent to the PCIe controller 200 after the priority receiver 202 receives 8 posted packets 210, consecutively. In some exemplary embodiments, the stop-count threshold may be specified as a packet count that is known to approximately correspond with the passage of a certain amount of actual time, based on the speed at which the PCIe interface 104 processes the packets. Furthermore, the actual time may correspond with a portion of the PCIe completion time-out.

Additionally, in some exemplary embodiments, a single counter may be used for both the non-posted packets 212 and the completion packets 214. In this case, the counter 224 may start when either a non-posted packet 212 or a completion packet 214 arrives in the non-posted RAM 218 or completion RAM 220. Additionally, the counter 224 may restart when a packet has been received by the priority receiver 202 from either of the non-posted RAM 218 or the completion RAM 220. In other words, the processing of either a non-posted or completion packet 214 may be sufficient to restart the counter 224. In other exemplary embodiments, the counter 224 may reset only if a packet is processed from the same RAM buffer 218 or 220 that caused the counter 224 to start. In other words, if the arrival of a non-posted packet in the non-posted RAM 218 causes the counter 224 to start, only the retrieval of a non-posted packet 212 from the non-posted RAM 218 will cause the counter 224 to reset. Conversely, if the arrival of a completion packet 214 in the completion RAM 220 causes the counter 224 to start, only the retrieval of a completion packet 214 from the completion RAM 220 will cause the counter 224 to reset.

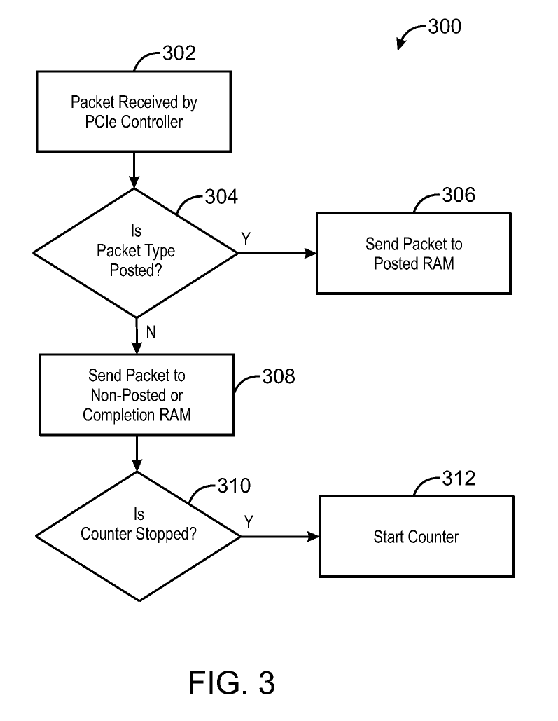

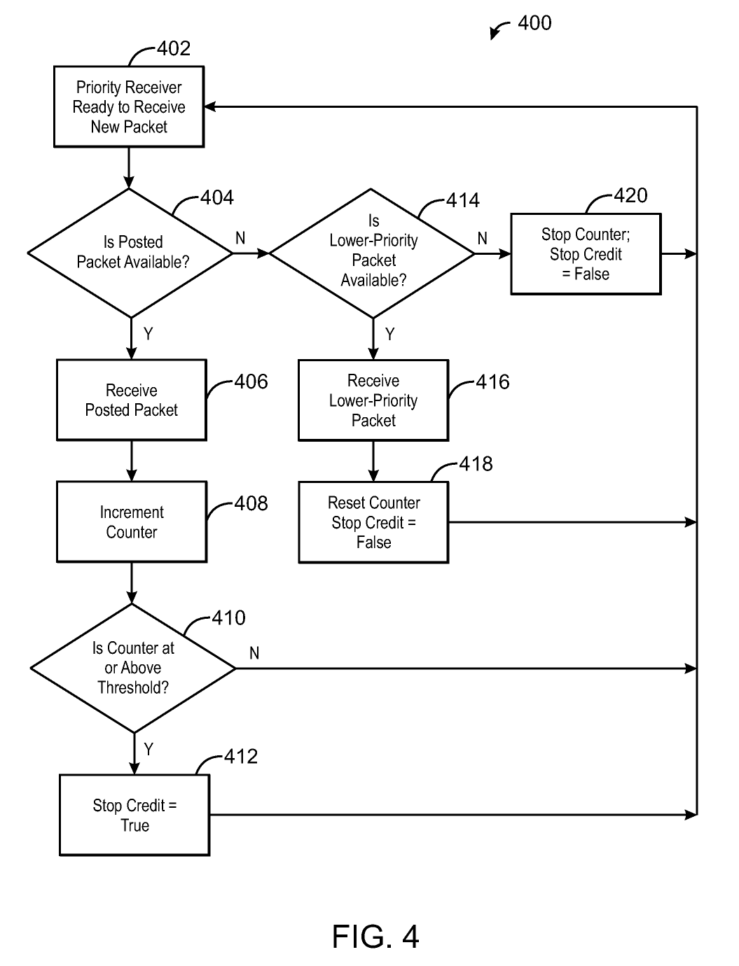

In an exemplary embodiment, separate counters 224 may be used for the non-posted packets 212 held in the non-posted RAM 218 and the completion packets 214 held in the completion RAM 220. In this embodiment, one of the counters 224 may track packets in the non-posted RAM 218, while one of the counters 224 tracks the completion RAM 220. Furthermore, each counter 224 may independently trigger the stop-credit signal 226 if either counter 224 reaches the stop-credit threshold. A different threshold may be set for each of the RAM buffers 218, 220, to tune the system for the number of packets received. The methods described above may be better understood with reference to FIGS. 3 and 4, which describe an exemplary method of transmitting packets from the host blade 102 to the NIC 106.

FIGS. 3 and 4 illustrate exemplary methods of transmitting packets from the host blade 102 to the NIC 106 through the PCIe interface 104. Moreover, FIG. 3 is directed to a method of receiving packets from the host blade 102, and FIG. 4 is directed to a method of sending packets to the NIC 106. As described above, the methods illustrated in FIGS. 3 and 4 may be executed independently by the PCIe interface 104 in the course of transmitting packets from the host blade 102 to the NIC 106.

FIG. 3 is a flow chart of a method by which a PCIe interface may receive packets from a host blade according to an exemplary embodiment of the present invention. The method 300 starts at block 302 when a packet is received by the PCIe controller from a host blade. Upon receipt of a packet, the method 300 advances to block 304. At block 304, the PCIe controller determines the packet type by interpreting the packet header containing the packet type information. If the packet is a posted packet 210, method 300 advances to block 306. At block 306, the packet is sent to the posted RAM 216. If the packet is a not a posted packet 210, method 300 advances to block 308. At block 308, non-posted packets 212 are sent to non-posted RAM 218 and completion packets 214 are sent to completion RAM 220. Method 300 then advances to block 310. At block 310, a determination is made regarding whether the counter 224 is stopped. If the counter 224 is stopped, this may indicate that the non-posted packet 212 sent to the non-posted RAM 218 or the completion packet 214 sent to the completion RAM 220 at block 308 is the only remaining lower-priority packet currently waiting to be processed. Therefore, if the counter is stopped, method 312 advances to block 312 and the counter is started. The starting of the counter begins the delay-reference tracking of the lower-priority packet. If the counter is not stopped, this may indicate that an earlier-arriving, lower-priority packet is currently waiting in the memory 204 and that the delay-reference of that packet is already being tracked. Therefore, if the counter 224 is not stopped the method 300 may end. Each time a new packet is received by the PCIe controller 200 method 300 may begin again at block 302.

FIG. 4 is a flow chart of a method 400 by which a PCIe interface may send packets to a network according to an exemplary embodiment of the present invention. Method 400 starts at block 402, when the priority receiver 202 is ready to receive a new packet from the memory 204. As discussed above in reference to FIG. 2, the posted packets 210 have the highest priority in an exemplary embodiment of the present invention. Therefore, a posted packet 210, if available, will be processed by the priority receiver 202 ahead of non-posted packets 212 or completion packets 214. Accordingly, the method 400 advances to block 404, wherein a determination is made regarding whether a posted packet 210 is available in the posted RAM 216. If a posted packet 210 is available, method 400 advances to block 406. At block 406, the priority receiver 202 receives a posted packet 210 from the posted RAM 216. The posted packet 210 is then processed by the priority receiver 202 and the posted packet 210 is queued for sending to the NIC 106.

As discussed above in reference to FIG. 2, the delay-reference tracking of the lower-priority packets may, in an exemplary embodiment, count the number of posted packets 210 that have been received by the priority receiver 202 since the last lower-priority packet was received by the priority receiver 202. Accordingly, after the priority receiver 202 receives a posted packet 210 at block 406, process flow may advance to block 408, wherein the counter 224 may be incremented. If the non-posted RAM 218 and the completion RAM 220 have separate counters 224, both counters 224 may be incremented. In some alternative embodiments, the counter 224 may measure actual time, in which case incrementing the counter 224 may occur independently of the receipt of posted packets 210, and block 408 may be skipped.

Next, at block 410 a determination is made regarding whether the counter 224 is at or above the stop-credit threshold. If the counter 224 is not at or above the stop-credit threshold, then process flow returns to block 402, at which time the priority receiver is ready to receive a new packet. If, however, the counter is at or above the stop-credit threshold, the method 400 advances to block 412. At block 412, the value “stop credit” is set to a value of “true,” and the priority receiver therefore, sends a stop-credit signal to the PCIe controller. As discussed above in reference to FIG. 2, sending the stop-credit signal to the PCIe controller causes the PCIe controller to stop sending flow control credits to the host blade. As a result, the host blade 102 will stop sending new packets to the PCIe controller 200, and the PCIe controller 200 will stop sending packets to the memory 204. Sometime after sending the stop-credit signal 226, therefore, the posted RAM 216 will run out of posted packets 210. When this occurs, process flow will move from block 404 to block 414. It should be noted, however, that the priority rules are not changed to enable the lower-priority packets to be received by the priority receiver 202. Rather, the lower-priority packets are not received until all of the posted packets 210 have been received first. This ensures that a later-arriving read request of a non-posted packet 212 is not transmitted to the NIC 106 before an earlier-arriving write request of a posted packet. As will be explained further below in reference to blocks 418 and 420, the stop-credit signal 226 may be maintained at a value of true until a lower-priority packet has been received by the priority receiver 216 or until several or all of the lower-priority packets have been received by the priority receiver 216.

Returning to block 404, if a determination is made that a posted packet 210 is not available because the posted RAM 216 is empty, then the priority receiver may receive a lower-priority packet. Accordingly, process flow may advance to block 414, wherein a determination is made regarding whether a lower-priority packet is available. If either a non-posted packet 212 or completion packet 214 is available in the non-posted RAM 218 or the completion RAM 220, process flow advances to block 416, and the lower-priority packet is received by the priority receiver 202.

If both a non-posted packet 212 and a completion packet 214 are available, the packet that is received by the priority receiver 202 will depend on the relative priority assigned to the non-posted packets 212 and the completion packets 214. Exemplary embodiments of the present invention may include any suitable priority assignment between non-posted packets 212 and completion packets 214. For example, at block 416 a higher priority may be given to either the non-posted packets 212 or the completion packets 214. As another example, the priority may alternate between the non-posted 212 and the completion packets 214 each time a lower-priority packet is received from the non-posted RAM 218 or the completion RAM 220. In this way, the priority receiver 202 may alternately process packets from the non-posted RAM 218 and the completion RAM 220, when posted packets 210 are not available. Other priority conditions may be provided to distinguish between the non-posted packets 212 and the completion packets 214 while still falling within the scope of the present claims.

After receiving the lower-priority packet, process flow may advance to block 418. At this time a lower-priority packet will have been received by the priority receiver 202. Therefore, if the counter 224 has previously been started and is currently tracking the delay-reference of the lower-priority packet, the delay-reference information stored by the counter 224 may no longer be current. Accordingly, at block 416 the counter 224 may be reset. Resetting the counter 224 causes the counter 224 to begin tracking a delay-reference of the next available lower-priority packet in the memory 204. In exemplary embodiments with two counters 224, for example, one counter 224 for the non-posted RAM 218 and one counter 224 for the completion RAM 220, the receipt of the lower-priority packet may only reset the counter 224 associated with the RAM buffer from which the lower-priority packet was received. In exemplary embodiments with one counter 224 for both non-posted and completion packets 214, the counter 224 may be reset regardless of whether a non-posted packet 212 or completion packet 214 was received.

In some exemplary embodiments, the stop-credit signal 226 may be activated (“stop-credit” set to true) for only as long as it takes to empty the posted RAM 216 and receive at least one low priority packet from the non-posted RAM 218 or the completion RAM 220. Accordingly, the stop-credit signal 226 may be deactivated (“stop credit” set to false) at block 418, as shown in FIG. 4. In response to turning off the stop-credit signal 226, the PCIe controller 200 may start issuing additional flow control credits to the host blade 102, and the PCIe controller 200 may once again begin receiving packets, including posted packets 210, and sending them to the memory 204. Therefore, in some exemplary embodiments, turning off the stop-credit signal 226 at block 416 may enable as few as one lower-priority packet to be processed before additional posted packets 210 become available in the posted RAM 216. In most cases, however, propagation delays between the host blade 102 and the PCIe controller 200 will cause a delay between the time that the stop-credit signal 226 is turned off and the time that new posted packets 210 begin to arrive in the posted RAM 216. This delay may enable the priority receiver 202 to receive several, or even all, of the low priority packets from the non-posted RAM 218 and the completion RAM 220 before a new posted packet 210 is sent to the posted RAM 216. Therefore, turning of the stop-credit signal 226 at block 416 after the receipt of one lower-priority packet may, in fact, enable several or all of the lower-priority packets to be received and processed by the priority receiver 202.

Moreover, turning the stop-credit signal 226 off at block 418 when there may still be several lower-priority packets in the non-posted RAM 218 and the completion RAM 220, enables efficient use of the PCIe interface 104 bandwidth. This is true because the speed at which the PCIe interface 104 transfers data from the host blade 102 to the NIC 106 is limited by the speed at which the priority receiver 202 can process packets from the memory 204. As long as the priority receiver 202 continues to receive a steady stream of packets from the memory 204, the stop-credit signal 226 will not significantly diminish the data transfer speed between the host blade 102 and the NIC 106. In other words, if the stop-credit signal 226 causes the memory 204 to empty before additional packets are delivered to the memory 204 from the PCIe controller 200, then the priority receiver 202 will experience a period of inactivity, wherein no packets are being delivered to the NIC 106 despite the fact that one or more host blade 102 have additional data packets to send to the NIC 106. Such a period of inactivity may reduce the average data transmission rate of the PCIe interface 104. However, a brief period wherein the PCIe controller 200 stops receiving packets does not significantly reduce the overall speed of the PCIe interface 104 as long as the priority receiver 202 continues receiving packets from the memory 204. Therefore, by turning off the stop-credit signal 226 in block 416 after only a single lower-priority packet has been received by the priority receiver 202, the likelihood of the priority receiver 202 experiencing a period of inactivity is reduced because the process of enabling the host blade 102 to send additional packets begins before the memory have been emptied.

On the other hand, in some embodiments, it may be advantageous to keep the stop-credit signal activated until both the non-posted RAM 218 and the completion RAM 220 are empty. Accordingly, in some exemplary embodiments, the stop-credit signal 226 may not be deactivated at block 418, but rather at block 420, as will be discussed below. After block 418, process flow returns to block 402, and the priority receiver 202 is ready to receive a new packet. Returning to block 414, if a lower-priority packet is not available, the method 400 advances to block 420. As discussed above, the stop-credit signal 226 may, in some embodiments, be turned off at block 420 rather than block 418. Thus, at block 420, the stop-credit signal 226 may be deactivated. As discussed above in relation to block 418, turning off the stop-credit signal 226 may cause the PCIe controller 200 to resume sending flow control credits to the host blade 102, and the PCIe controller 102 may begin receiving additional packets from the host blade 102. Additionally, the delay-reference counter 224 may be stopped at block 420 because there are no longer any lower-priority packets available in the non-posted RAM 218 and the completion RAM 220. Referring briefly to FIG. 3, it will be appreciated that the counter 224 will be restarted at block 306 as soon as an additional lower-priority packet is sent to the non-posted RAM 218 or the completion RAM 220. After block 420, method 400 returns to block 402, and the priority receiver 202 is ready to receive a new packet from the memory 204.

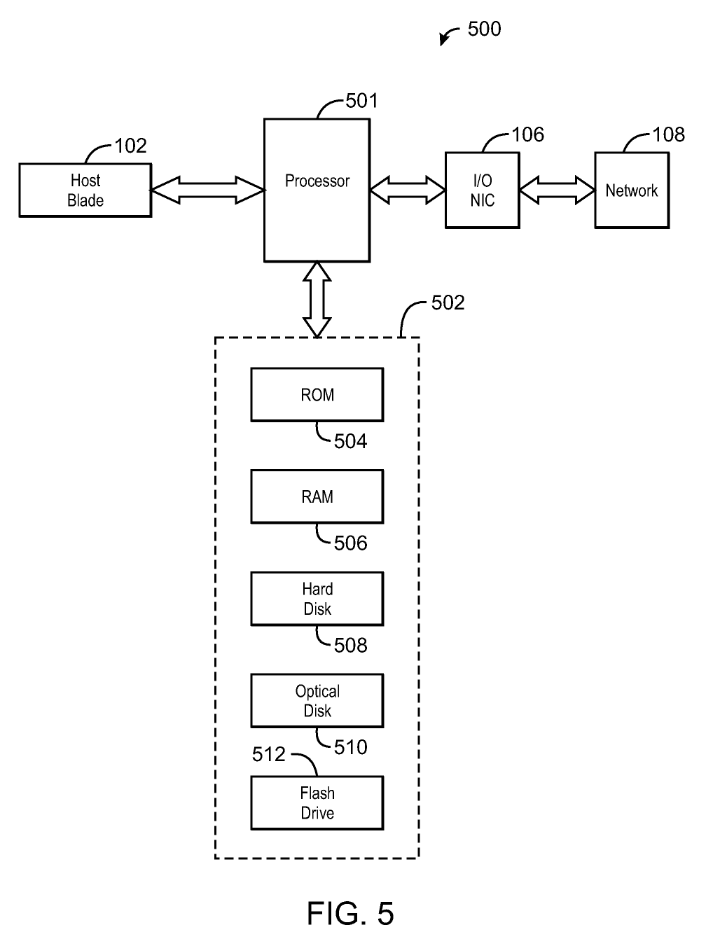

FIG. 5 is a block diagram of a computer system that may embody one or more of the functional blocks of the PCIe interface shown in FIG. 2, according to an exemplary embodiment of the present invention. The computer system is generally referred to by the reference number 500. A processor 501 is communicatively coupled to the host blade 102 and NIC 106, which couples the processor 501 to the network 108, as discussed in relation to FIG. 2.

Furthermore, the processor 501 may be communicatively coupled to a tangible, computer readable media 502 for the processor 501 to store programs and data. The tangible, computer readable media 502 can include read only memory (ROM) 504, which can store programs that may be executed on the processor 501. The ROM 504 can include, for example, programmable ROM (PROM) and electrically programmable ROM (EPROM), among others. The computer readable media 502 can also include random access memory (RAM) 506 for storing programs and data during operation of the processor 501.

Further, the computer readable media 502 can include units for longer term storage of programs and data, such as a hard disk drive 508 or an optical disk drive 510. One of ordinary skill in the art will recognize that the hard disk drive 508 does not have to be a single unit, but can include multiple hard drives or a drive array. Similarly, the computer readable media 502 can include multiple optical drives 510, for example, CD-ROM drives, DVD-ROM drives, CD/RW drives, DVD/RW drives, Blu-Ray drives, and the like. The computer readable media 502 can also include flash drives 512, which can be, for example, coupled to the processor 501 through an external USB bus.

The processor 501 can be adapted to operate as a communications interface according to an exemplary embodiment of the present invention. Moreover, the tangible, machine-readable medium 502 can store machine-readable instructions such as computer code that, when executed by the processor 501, cause the processor 501 to perform a method according to an exemplary embodiment of the present invention.

What is claimed is:

1. A computing system, comprising:
a first buffer configured to hold packets of a first packet type, and a second buffer configured to hold packets of a second packet type;
a counter configured to track a delay-reference of packets held in the second buffer; and
a controller configured to receive packets from a host and send packets of the first packet type to the first buffer and to send packets of the second packet type to the second buffer, the controller being further configured to stop receiving packets if the delay-reference meets or exceeds a specified threshold.

2. The computing system of claim 1, comprising a receiver configured to receive the packets from the first buffer and the second buffer and to send the packets to a network, the receiver being further configured to receive packets from the second buffer only if the first buffer is empty.

3. The computing system of claim 2, wherein the controller is configured to prevent the host from sending packets to the controller in response to a stop-credit signal sent from the receiver to the controller in response to the delay-reference meeting or exceeding the specified threshold.

4. The computing system of claim 1, wherein the controller is configured to allow the host to send packets to the controller after at least one packet from the second buffer is received by the receiver.

5. The computing system of claim 1, wherein the first buffer is configured to store posted packets and the second buffer is configured to store non-posted packets or completion packets.

6. The computing system of claim 1, wherein the specified threshold corresponds with a portion of a PCIe completion timeout interval.

7. The computing system of claim 1, wherein the delay-reference comprises a total number of packets that have been received from the first buffer since that last packet was received from the second buffer.

8. The computing system of claim 1, wherein the delay-reference comprises an amount of time that the packets have been held in the second buffer.

9. The computing system of claim 1, wherein the controller operates according to a Peripheral Component Interconnect Express (PCIe) protocol.

10. A method of controlling transaction flow in a communications interface, comprising:
receiving packets that comprise higher-priority packets and lower-priority packets;
sending the packets to a network;
tracking a delay-reference of the lower priority packets; and
stopping the receiving of packets if the delay-reference meets or exceeds a specified threshold.

11. The method of claim 10, wherein sending packets to the network comprises sending a lower-priority packet only if a higher-priority packet is not available.

12. The method of claim 10, comprising re-setting the delay-reference if a lower-priority packet is sent to the network.

13. The method of claim 10, comprising incrementing the delay-reference if a higher-priority packet is sent to the network.

14. The method of claim 10, wherein stopping the receiving of packets comprises stopping the sending of transaction control credits to the host.

15. The method of claim 14, comprising resuming the sending transaction control credits to the host if at least one lower-priority packet is received from the buffer.

16. A tangible, machine-readable medium, that stores machine-readable instructions executable by a processor to perform a method for operating a communication link, the tangible, machine-readable medium comprising:
machine-readable instructions that, when executed by the processor, cause the processor to receive packets from a host, the packets comprising higher-priority packets and lower-priority packets;
machine-readable instructions that, when executed by the processor, cause the processor to send the packets to a network;
machine-readable instructions that, when executed by the processor, cause the processor to track a delay-reference of the lower priority packets; and
machine-readable instructions that, when executed by the processor, cause the processor to stop receiving packets if the delay-reference meets or exceeds a specified threshold.

17. The tangible, machine-readable medium of claim 16, comprising machine-readable instructions that, when executed by the processor, cause the processor to send lower priority packets to the network only if no higher-priority packets are available.

18. The tangible, machine-readable medium of claim 16, comprising machine-readable instructions that, when executed by the processor, cause the processor to process posted packets as the higher-priority packets and process non-posted packets and completion packets as the lower priority packets.

19. The tangible, machine-readable medium of claim 16, comprising machine-readable instructions that, when executed by the processor, cause the processor to begin receiving packets from the host after at least one lower-priority packet has been sent to the network.

20. The tangible, machine-readable medium of claim 16, comprising machine-readable instructions that, when executed by the processor, cause the processor to send a stop-credit signal to the host in response to the delay-reference meeting or exceeding the specified threshold.
